(19) United States
(12) Patent Application Publication
(10) Pub. No.: US 2008/0171514 A1
(43) Pub. Date: Jul. 17, 2008

(54) METHOD FOR OPERATING A SERVICE BY A HOST SYSTEM WITH A HUMAN-MACHINE INTERFACE, THE HOST SYSTEM AND THE MOBILE ELECTRONIC DEVICE AND HOST SYSTEM PACKAGE

(75) Inventors: David Gaborit, Tignet (FR); Richard Lee, Pont Du Loup (FR); Chris Wild, Le Rouret (FR); Marc Grant, Bar Sur Loup (FR); Christophe Fava-Rivi, Nice (FR)

Correspondence Address: AKERMAN SENTERFITT, P.O. BOX 3188, WEST PALM BEACH, FL, 33402-3188, US

(73) Assignee: Siemens VDO Automotive, Toulouse (FR)

(21) Appl. No.: 11/969,304

(22) Filed: Jan. 4, 2008

(30) Foreign Application Priority Data
Jan. 5, 2007 (FR) 0700058

(51) Int. Cl. H04B 7/00

(52) U.S. Cl. 455/41.3

(57) ABSTRACT

The invention relates to a method for operating a service in an environment outside a mobile electronic device. The service is able to be operated by means of a host system with a human-machine interface adapted to the environment. The mobile device is brought into communication with the host system which senses the operability of the service by the mobile device, the host system is downloaded with a proxy for operating the service and the service operation is transferred onto the host system by means of its human-machine interface. The host system comprises means for reproducing information, controlling means for a user, a communication processor, a memory for storing a proxy software for operating a service and a processor for operating the proxy software.

The present invention relates to so-called HMI or MMI/HMI, standing for “man/human machine interface” used both for remote services provided by operators as well as for resident (“stand-alone”) services, on mobile electronic devices or facilities, also referred to as CED (“consumer electronic device”) and on stationary computer stations or other radio bases related to stationary stations.

CED's could be mobile phones, portable computers (“laptop”), personal assistants (or PDA referring to “personal digital assistant”), GPS explorers (“global positioning system”), walkmen or other MP3 audio players (such as those belonging to the “iPod” registered trade mark), etc.

Mobile telephones could themselves access various types of services provided by operators, such services as broadcasting information such as road navigation, road traffic, tourism, weather forecasts, booking, repairing, commercial or stock exchange information, etc.

Stationary stations could be office computers (PC or “personal computer” or others), including with multimedia applications, home automation bases (radio or with carrier currents) adapted to control home automated facilities (multimedia, heating or air conditioning, various closing operations, etc.) or stationary telephone bases (either wired or wireless such as DECT telephone bases) or on-board ones, such as radio-telephones on board of automobile vehicles.

As CED's are mobile devices, they necessarily have a very small size and only have available an insufficient IHM for multimedia applications or Internet (WAP network) or even for electronic mail: miniature screens, inappropriate input interfaces, poor audio quality sound transducers, poorly adapted mechanical fixtures of the housing and functionalities of the device, etc.

In contrast, dimensions of stationary stations are not limited. Stations could be provided with an ergonomic IHM being adapted to the environment.

Correlatively, CED and stationary stations have emerged on the market, being capable of communicating between them by means of local radio communication networks (Bluetooth, Wifi, USB radio . . . ) or wired ones (USB referring to “universal serial bus”).

As an example, there are presently between GSM (“Global System Mobile”) mobile telephones and DECT stationary telephone bases exchanging means allowing the user to only sign up for one subscription, the mobile telephone being operational outside home and the stationary telephone substituting for the mobile telephone when the mobile telephone owner is at home.

Similarly, there are automobiles where the cabin is provided with a telephone device, being both stand-alone and able to be used in combination with the mobile telephone of the driver or of one of his passengers.

When the mobile telephone owner is in the vicinity of the stationary telephone of the vehicle, the latter detects the mobile telephone, receiving the subscriber's particulars (SIM card content) thereof which it directly uses, with the benefit of using its IHM being adapted to the car cabin environment and the vehicle driving.

But, although all the services provided by the GSM operator of the mobile telephone (mobile telephone communication, Internet navigation, travelling and weather forecast information, multimedia broadcast, etc.) are available through the cabin telephone, the latter is unable to take advantage of them.

In other words, the human/machine interface of the host device, herein the vehicle on-board telephone, is only useable for one single service, the telephone service. It cannot either be adapted to any technological evolution of the telephone network services, which are known for their extensive proliferation. It cannot either be adapted to other services without some complex and expensive adaptation.

To sum up, as the host interface devices of the above described type are very specific and proprietary, have the inconvenient of a lack of adaptability to services and a very low technological durability. In one word, they are not multipurpose and become obsolete very quickly.

The Applicant has tried to overcome such a lack of adaptability and durability of host systems.

To this end, this invention relates first to a method for operating at least one service in an environment outside a mobile electronic device, wherein the service is operable, and by means of a host system with a human machine interface being adapted to the environment, said method wherein the mobile device is brought into communication with the host system that detects the operability of the service by the mobile device, the host system is downloaded with a service operating proxy and the service operation is transferred to the host system by means of its human-machine interface.

Thus, the user-friendly IHMH being adapted to the considered environment is associated with the intelligence of the mobile device (CED) via the proxy, being a nearby vicinity buffer software processing means used as a proxy for the CED for the transmission of requests.

This invention does not rely on increasing the processing or intelligence abilities of the user's system, as would be commonly done for better and more completely becoming adapted to the different available technological devices and services, but on the contrary, relies on removing from the system its own processing functions so as to reduce it to a multipurpose host human-machine interface (IHMH) by means of at least one proxy.

Thus, this invention proposes to adapt the IHMH user-friendliness to the CED processing power.

In a particular embodiment of the method according to the invention, the service is a service provided by an operator and only operable by the mobile device, for example, a guiding service.

In another embodiment of the method according to the invention, the service is a direct service of the mobile device, for example a dictionary service (in such a case, the mobile device is referred to an isolated “stand-alone” device.

The service operating proxy could be downloaded from the service operating mobile device or from a server.

Advantageously, for operating the service from the host system, a software is also downloaded for defining information presentation characteristics on the human-machine interface in the host system.

This invention also relates to a host system with a human-machine interface for operating the method of the invention, comprising information reproducing means and control means for a user, said system being characterized in that it also comprises at least one communication processor, a storing memory for a service operating proxy software and a microcontroller/processor for operating the proxy software.

In the preferred embodiment of the host system of this invention, there is provided at least one of the package components comprising a mass memory, a central processing unit (CPU), a graphical controller, a vocal control member (microphone, loudspeaker), a “carrier” bus controller (CAN, MOST).

Preferably, the host system comprises a media hub software provided for downloading, storing and operating the proxy software.

This invention finally relates to a service implementing package comprising at least one service operating mobile electronic device with a human-machine interface, a host system according to the invention in an environment external to the mobile device with a human-machine interface and means arranged for transferring the human-machine interface operation of the device to the human-machine interface of the host system.

Preferably, the host system is provided for detecting the presence of the mobile device and the operability thereof for a service.

In a particular embodiment, the package of the invention comprises a proxy downloading server.

By means of this invention, in the example of vehicles, the mobile device, which does not need to be mechanically mounted with some ergonomics related to its use, it is possible to use the on-board screen of the vehicle, i.e. the screen of the host system, with the appropriate size, and the interfaces as provided in the cabin, while integrating, amongst others, quality loudspeakers and control buttons on the steering-wheel, improving the safety.

In addition, in this same example of vehicles, data exchanges could be provided for between the device or the service operator and the vehicle on-board calculator, for example, also for sending engine test data to a repairing station.

Other features and advantages of the present invention will become more apparent reading the herein below mentioned description of the method of the service operating host system and the package of the system and a service operating mobile electronic device according to the invention, referring to the appended drawing wherein:

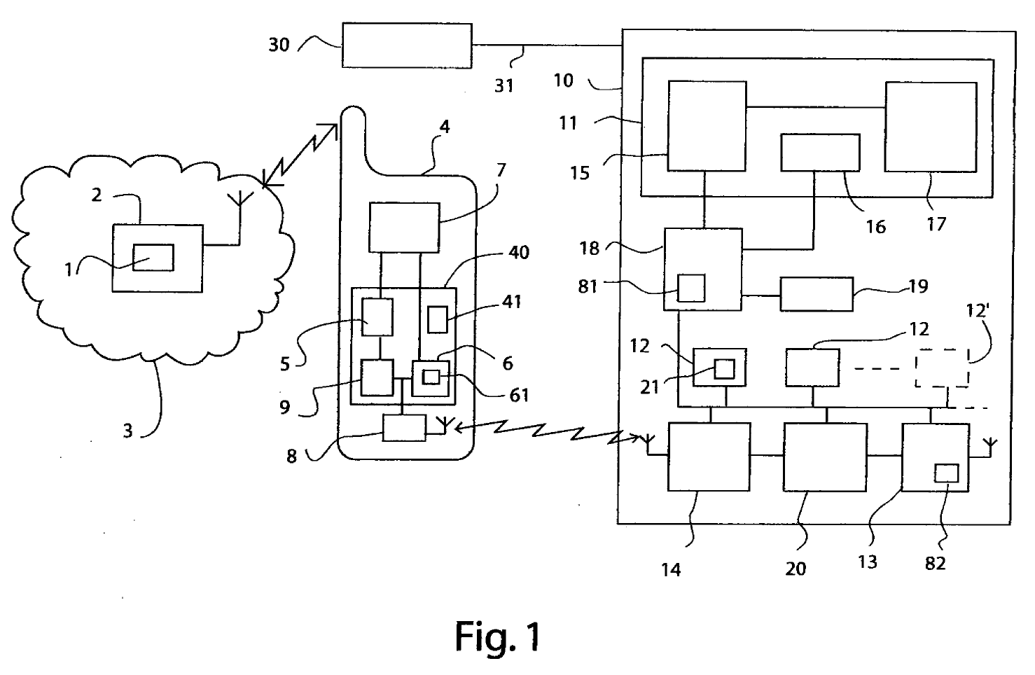

FIG. 1 is a functional block diagram of the package of the service operating host system and a mobile electronic device, and

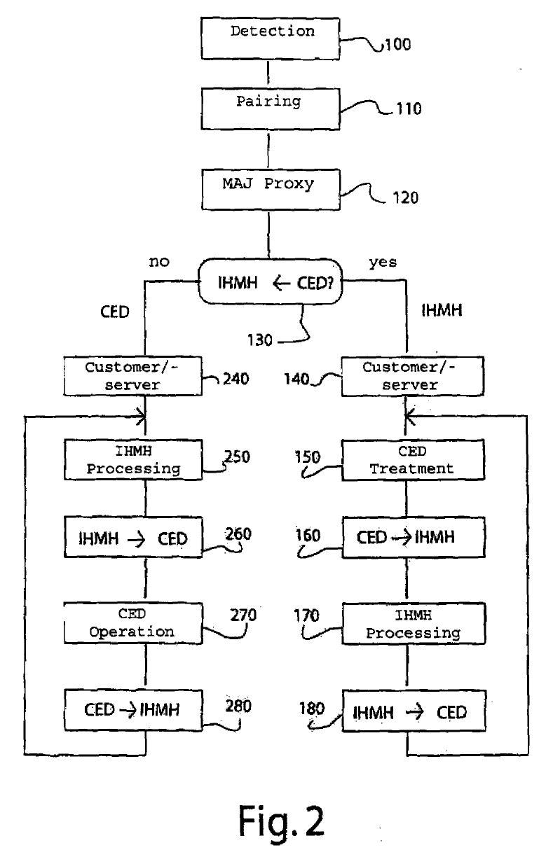

FIG. 2 is a flow diagram illustrating the steps of the method according to this invention.

Referring to FIG. 1, a predetermined service, illustrated by block 1, is provided, according to a first embodiment, by an operating centre 2 on the Web 3. A CED mobile electronic device 4, here a GSM mobile telephone, has access to it through its Internet explorer 5 and is able to operate it conventionally, for example by the explorer 5, a service 1 processing application 9 or a direct service 9 processing application.

The service 1 could, for example, be a service such as booking, tourism or weather forecast information, automobile navigation or even a navigation service or an electronic mail service on Internet. But, such a list is not exhaustive.

Another embodiment, similar to the above described one, is only different in that the service 1 is replaced by a direct service 9, i.e. a service exclusively present in the device 4, for example, an application 9. Herein below, the reference 9 represents an application as well as a service.

The application 9 could for example be an electronic diary, a dictionary, a book-keeping application and the like.

Whatever the implementation, the portable device 4 application 9 is connected with an editor and an IHM 7, arranged for shaping and reproducing information for a user of the device 4. The IHM 7 conventionally comprises a screen and a keyboard (with no reference numerals).

The mobile telephone 4 comprises a local radio port, here Bluetooth 8, connected with the editor 6, being provided for transmitting and receiving data at the radio port 8 as well as at the IHM 7, as will be described further in the description.

Furthermore, and here in the cabin of a car (not shown), a host system 10 is provided for implementing the same service 1 or 9 by means of its IHM 11 adapted to the cabin and being permanently fixed in said cabin.

The cabin of a vehicle is only considered by way of an example; a home could also be contemplated.

The host system 10 and the telephone 4 form the above described package.

Here, the system 10 is a multipurpose host human-machine interface (IHMH). The resources 5, 9, 6 of the telephone 4 are software arranged in a computing unit 40 of the CED 4.

The IHMH 10 senses the Bluetooth emissions from the CED 4, or conversely, through polling (as is well known to the one skilled in the art) through the presence of a Bluetooth processor 14. Exchanging initial frames allows the IHMH 10 to know whatever service 1 or 9 is able to be operated by the CED 4.

For operating the service 1 or 9, a passenger or the driver of the telephone 4 owner vehicle could either use his telephone 4, and undergo the above described disadvantages or, if it is operational, use the system or IHMH 10, with all the also above described advantages.

In this latter case, indeed, concurrently, the mobile telephone 4 operates the service 1 through resources 5, 9 and 6 as if it were operated, checked and controlled by its own IHM 10, but this is through the IHM 11 of the IHMH 10 via the Bluetooth link between the port 8 and the processor 14 that such an operation and such a checking/control are performed. The IHM of the telephone 4 is transferred to the host system 10.

This is made possible by means of the presence in the IHMH 10 of a proxy 12 of the application 9 or the service 1.

The person skilled in the art is aware of the operating principle for the proxy software models. Such software have representing proxy functions, and they are encoded for a particular environment, here the environment of the IHM 11, for a determined service 1 and independently from the features of the CED 4.

The processor 14 senses and receives Bluetooth signals emitted by the port 8 of the telephone 4 and sends them to the proxy 12. Such signals provide, for example, to the interface 11 of the RSS (“Really Simple Syndication” or “Rich Site Summary” or “RDF Site Summary”) compliant data or other data of the same type, as explained herein below.

The “RSS” of an Internet site is a summary of the site representing the framing of its computing resources. It forms a standard able to gather information from different applications of the application type 9 and provides for a customized display or reproduction, here on the IHM 11, of information received by the user.

The RSS data are here received in a “media hub” 13, containing a RSS reading software for definition of information presentation features.

It is to be reminded that “RSS” is a family of content syndication protocols on Internet, based on a XML technology (“extensible markup language”) primarily used by news sites, weblogs and podcasts. Operating RSS procedures is well known to the person skilled in the art, either via a modem (not shown) of the telephone 4, or by the proxy 12 corresponding to a RSS reader 61, here included in the editor 6, but being able to be included in the application 9 of the telephone 4, depending on the application, and 21 included in the proxy 12.

Usually, a hub is a material member allowing to retrieve binary data (here RSS data) on a port, to regenerate and send them again on several ports operating on the first OSI layer (“Open System Interconnection”).

It will be understood that using such a RSS exchange technology allows for the processing, by the hub 13 and the IHMH 10, of several different services 1 and of several different applications 9 of the telephone 4 for being operated as a function of the user's requirements, as long as such applications 9 or services 1 belong to the application package using the RSS protocols.

Regarding the other applications 9 incompatible with the RSS protocols, for example, the processing of electronic mail or the Internet navigation, another proxy 12, or another means that will be referred to herein below, is required in the IHMH 10 for fulfilling the same functions of the IHM 11 and together a software 61 similar to the RSS reader is required in the telephone 4.

Here the hub 13 has much more extended functions than an ordinary hub. Before the concentration of the RSS features in the human-machine interface adapted to the environment of the IHMH 10, of the application 9 of the service 1, it controls the downloading thereof. It downloads them from the CED 4, or the centre 2 of the operator in the IHMH 10, by means of downloading means 82, in order to reproduce them on the IHM 11.

The hub 13 is further responsible for selecting the proxy 12 that is required for the requested service 1 and activating it whenever needed, if present (otherwise, it causes it to be downloaded, as will be explained herein below, controlling the downloading means).

Preferably the hub 13 is of the SPP type, so as to sense itself the presence of the mobile device 4. It then also senses Bluetooth emissions and activates proxies 12.

The hub 13 could optionally be substituted for the proxy 12, for example, for transmission of electronic mails.

The IHMH 10 finally comprises OSI layers (or “stacks”) 20 of Bluetooth communication necessary to the proxies 12 and the hub 13.

The IHM 11 finally comprises a control keyboard 16 (or a vocal control comprising a microphone and a loudspeaker) and a graphical controller 15 for being able to reproduce information on a screen 17 and perform the check-control of the service 1. Optionally, a central processing unit 18, or a microcontroller 18, and a mass storage 19 provide for the management of the package.

All the above described functional means 12, 13, 15, 18, 20 could preferably be programmed by separate processors (chips).

According to a first embodiment, each proxy 12 is previously installed in the IHMH 10 and the hub 13 is initialized for bias it upon use. If the proxy 12 is implemented on a processor, such a processor is integrated into the IHMH 10.

According to a second embodiment, only locations 12′ of the proxies 12 are provided and preserved. When a proxy 12 becomes necessary for operating the service 1, it is downloaded into the IHMH 10 from a downloading server 30 that could be included in the centre 2 of the service operator 1 himself via the CED 4. But the downloading server 30 could be independent and connected with the CED 4 conventionally (USB or other) by a local network 31 or a direct computing link 31.

In order for allowing the proxies 12 to be downloaded, proxy loading functions 41 and 81 are provided for, respectively located in microcontrollers 40 and 18. But downloading means 82 arranged in the hub 13 could also be used.

The proxy 12 is downloaded by the function 81 or 82 into an empty processor 12′ initially provided to this end in the IHMH 10. Correlatively, the hub 13 is initially provided for comprising logical links allowing it to activate proxy 12 when it is downloaded.

According to this second embodiment, the IHMH 10 must not contain any proxy 12, but only preserved locations 12′, and, upon its use, the hub 13, sensing a telephone 4 through a Bluetooth link and sensing, in the initial frames of Bluetooth exchanges, a need for downloading the proxy 12, activates the downloading function 81 or 82 of the proxy in the predetermined or calculable address preserved location 12′ and memorizes such an address accompanied with features of the downloaded proxy 12 so as to be able to perform its activation.

The global operation of the sytem comprising the service 1 operator centre 2, the telephone 4 and the IHMH host system 10 will now be explained, referring to FIG. 2.

When a user, bearing the telephone 4 is in a Bluetooth area of the IHMH 10, in a step 100, the proxy 12 or the hub 13 senses the presence of the telephone 4 either through voluntary activation, or through polling or periodical polling.

In such a step 110, both devices 4 and 10 perform a Bluetooth “pairing” operation, through a conventional initial frame exchange (for example, SPP type).

In the initial frames being exchanged, in step 120, the telephone offers the service 1 it has available to the hub 13, for example one of the just mentioned services. Such an operation could be bidirectional and could generate immediately proxy 12 downloads, as is being observed herein above.

The user has thus the option, in a step 130, either to use his telephone 4 and its interface 7 or the IHMH 10 and its interface 11.

If he prefers the latter solution, he only has to use the interface 11 commands. His request then activates a step 140 transferring the operation of the service 1 on the host system 10 by means of its human-machine interface 11.

For doing so, the hub 13 selects the good proxy 12, and accordingly, the good application 9, allowing for a connexion of the customer/server type between the IHMH 10 and the CED 4 including the RSS software for the definition of the information presentation features on the human-machine interface.

More precisely, the hub 13 selects the proxy 12 corresponding to the request introduced on the IHM 11 and the proxy 12 transmits such a request to the editor 6 which recognizes the application 9 corresponding to the proxy 12 and transmit it thereto.

If, at that time, the proxy 12 is still absent, the hub 13 previously initiates its download, as well as the RSS data (or the like) it needs, by means of its function 82 (or the microcontroller 18 by its function 81) from the CED 4 in a preserved location 12 before handing the control over to it.

The application 9 then processes, in a step 150, the service 1 according to a request, and in a step 160, retransmits the results or the requests of the service 1 to the IHM 11 by the same Bluetooth channel and the same proxy 12.

In a step 170, the IHM 11 displays or emits, the case being, the results or the requests of the service 1 and can bias, in a next step 180, the expression of a new user request and cause a new step 150 to be performed. And so on.

It can be seen that, concurrently, the service 1 is processed in the mobile electronic device 4 through the application 9 and, for taking profit of this, the human-machine interface 11 of the IHMH 10 is operated by means of a proxy 12.

Conversely, if the user prefers using his telephone 4, it should be provided that it is sufficient to use the interface 7 controls. It then activates, in a step 240, a customer/server relationship opposite to the previous one, as long as the telephone 4 has a structure symmetrical to that of the IHMH 10. Following steps 250 to 280 symmetrical to steps 150 to 180 herein above are performed afterwards.

Thus, and for taking again an already mentioned example, using a bidirectional hub connected with the vehicle computing bus, data exchanges could be initiated between the vehicle on-board calculator and a repairing service via the CED 4.

It can be seen that, concurrently, the BITE integrated test equipment (“built-in test equipment”) are being processed in the IHMH 10 through their microcontroller 18 and, for emitting the message containing test results in real time to a repairing service, the human-machine interface 7 and the explorer 5 of the CED 4 are operated by means of an electronic mail emitting application 9.

1. A method for operating at least one service in an environment outside a mobile electronic device, wherein the service is operable, and by means of a host system with a human-machine interface being adapted to the environment, said method comprising:
bringing the mobile device into communication with the host system;
sensing the operability of the service by the mobile device;
downloading the host system with an operating proxy of the service; and
transferring the service operation to the host system by means of its human-machine interface.

2. A method according to claim 1, wherein the service is a direct service (9) of the mobile device.

3. A method according to claim 1, wherein the service is a service provided by an operator and only operable by the mobile device.

4. A method according to claims 1, 2, or 3, wherein the proxy for operating the service is downloaded from the mobile device for operating the service.

5. A method according to claims 1, 2, or 3, wherein the proxy for operating the service is downloaded from a server.

6. A method according to claims 1, 2, or 3, wherein, for operating the service from the host system, there is also downloaded a software for defining information presentation features on the human-machine interface in the host system.

7. A host system for operating at least one service in an environment outside a mobile electronic device, wherein the service is operable, said host system being adapted to the environment, the system comprising:
a human-machine interface having means for reproducing information and means for user control;
at least one communication processor;
one storing memory for a proxy software for operating the service; and one processor for the operation of the proxy software,
wherein the host system is downloaded with an operating proxy of the server and the service operation is transferred to the host system by means of the human-machine interface responsive to the mobile device being brought into communication with the host system and sensing the operability of the service.

8. A system according to claim 7, further comprising:
a mass memory;
a central processing unit;
a graphic controller;
a vocal command member; and
a carrier bus controller.

9. A system according to claims 7 or 8, further comprising a media hub software provided for downloading, storing and operation the proxy software.

10. A service operating package comprising:
at least one mobile electronic device for operation the service with a human-machine interface;
a host system in an environment outside the mobile device with a human-machine interface; and
means provided for transferring the operation of the human-machine interface from the mobile device onto the human-machine interface in the host system.

11. A package according to claim 10, wherein the host system is configured for sensing the presence of the mobile device and its operability for a service.

12. A package according to claims 10 or 11, further comprising a server for downloading a proxy.
